(19) United States
(12) Patent Application Publication
(10) Pub. No.: US 2026/0279105 A1
(43) Pub. Date: Sep. 17, 2026

(54) User Detection For Physical Conference Space Check-In

(71) Applicant: Zoom Communications, Inc., San Jose, CA (US)

(72) Inventors: Robert Aaron Klegon, Chicago, IL (US); Nicholas Paul Mueller, Fitchburg, WI (US); Carleigh Pereira Noble, Chicago, IL (US)

(21) Appl. No.: 19/080,109

(22) Filed: Mar. 14, 2025

(51) Int. Cl. G06V 40/70; G06V 40/16; H04L 12/18

(52) U.S. Cl. CPC G06V 40/70; G06V 40/168; G06V 40/172; H04L 12/1818

(57) ABSTRACT

User detection is performed to check a physical conference space in for use during a video conference. In response to detecting a person within a physical conference space based on sensor output, an identification operation is performed to authenticate an identity of the detected user. For example, the identification operation may include one of a facial recognition process or a speech recognition process. The system determines a name of the person based on the identification operation and automatically compares same against a participant list for the video conference for which the physical conference space is reserved. Where a match is determined, the system automatically checks the physical conference space in for the video conference.

### FIELD

This disclosure generally relates to physical conference spaces, and, more specifically, to systems and techniques for using user detection to check a physical conference space in for use during a video conference or other synchronous communication.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of a software-based room system for conferencing software services.

FIG. 6 is a block diagram of an example of a system for user detection for physical conference space check-in.

FIG. 7 is a block diagram of example functionality of physical conference space check-in software.

FIG. 8 is a swim lane diagram of an example of a user detection process performed to check-in a physical conference space.

FIG. 9 is a flowchart of an example of a technique for user detection for physical conference space check-in.

### DETAILED DESCRIPTION

Conferencing software is frequently used across various industries to support video-enabled conferences between participants in multiple locations. In some cases, each of the conference participants separately connects to the conferencing software from their own remote locations. In other cases, one or more of the conference participants may be physically located in and connect to the conferencing software from a conference room or similar physical conference space (e.g., in an office setting) while other conference participants connect to the conferencing software from one or more remote locations. Conferencing software thus enables people to conduct video conferences without requiring them to be physically present with one another. Conferencing software may be available as a standalone software product or it may be integrated within a software platform, such as a unified communications as a service (UCaaS) platform.

In some cases, a physical conference space (e.g., a conference room or office) may be equipped with a software-based room system to provide an integrated video conferencing experience for conference participants within the physical conference space. Conventional software-based room systems use a computing device, such as a desktop or laptop computer, to run software for configuring other devices (e.g., one or more cameras and display) of the physical conference space for use with video conferences. The computing device is also used to connect to server-side conferencing software that facilitates such video conferences to enable anyone in the physical conference space to participate in a video conference with participants attending from locations other than the physical conference space, for example, via the configured other devices. In a simple use case, a single display and a single camera of the physical conference space may be used. In more complex use cases, multiple displays and/or multiple cameras of the physical conference space may be used.

A video conference may be attended by one or more participants located within such a physical conference space made available for use during the video conference (hereinafter referred to as “in-person participants”) and one or more participants located other than at that physical conference space (hereinafter referred to as “remote participants”). Typically, the in-person participants to a video conference will connect to the video conference via a single computing device of the physical conference space they are in (i.e., a physical conference space computing device), while remote participants may connect to the video conference using their own computing devices (i.e., remote computing devices). Thus, while video streams from the remote computing devices may depict individual remote participants, a video stream from the physical conference space computing device will typically depict at least as many of the in-person participants as are within a field of view of a camera used by the physical conference space computing device to capture the video stream.

Recent approaches for video conferencing from a physical conference space, such as a conference room, include services for determining the names of participants of video conferences within a physical conference space and visually presenting their names in connection with the video conference in one or more graphical user interface configurations. In particular, one such recent approach annotates a conference video stream with participant name information determined via one or both of image processing (e.g., via facial recognition) or audio processing (e.g., via speech recognition), in either case in full accordance with user consent provided before any such processing occurs. While these automated approaches to user detection are valuable, they only begin identifying conference participants after a video conference has already actively started. Thus, conference participants joining a video conference from a physical conference space must initiate or join the video conference first to initiate these identification processes, without which participant names are not automatically identified.

As such, approaches such as those described above suffer technical drawbacks. For example, because a conference participant (i.e., a user of the subject system) must first initiate or join the video conference before they can be identified, processes for checking into the physical conference space may be ignored. That is, in many cases, the physical conference space is reserved (e.g., scheduled) for use with a video conference. A reservation system that facilitates this may require that an authorized person (e.g., a host or other participant of the video conference with host-like privileges) check into the physical conference space. Such a system may revoke a physical conference space reservation if, after some period of time, the system does not determine that the physical conference space has been checked into. This outcome is particularly troublesome where it is unclear who is present in the physical conference space, leading to scheduling conflicts and a lack of clarity regarding use of the space.

However, merely attempting to address these technical drawbacks via automatic detection of any occupant of the physical conference space may result in false positive events. For example, where a person briefly enters the physical conference space for a private phone call, an automated process configured simply to detect that the person is present in the space may mistakenly check the physical conference space in for a video conference for which the space is reserved. Such a false positive event may create conflicting reservation records and/or prevent legitimate usage of the physical conference space for the original reservation. Moreover, such person detection may in some cases raise privacy and security concerns, as uninvited individuals may be inadvertently added to the participant list of a subject video conference. These technical drawbacks emphasize a need for a precise, context-aware participant authentication approach for physical conference spaces that ensures accurate check-ins of the spaces while preserving user privacy and avoiding erroneous reservation creation.

Implementations of this disclosure address problems such as these using user detection to check a physical conference space in for use during a video conference or other synchronous communication. According to the implementations of this disclosure, user detection is performed using output generated by a sensor (e.g., a motion sensor) within a physical conference space (e.g., a conference room). In response to detecting a person within the physical conference space based on this output, an identification operation is performed to authenticate an identity of the detected user. For example, the identification operation may include one of a facial recognition process performed using an image previously obtained for the given participant (e.g., uploaded by the given participant before or at a beginning of the video conference) or a speech recognition process is performed using a voiceprint previously obtained for the given participant (e.g., uploaded by the given participant before or at a beginning of the video conference). The system determines an identity (e.g., a name) of the person based on the identification operation and automatically compares same against a participant list for a video conference for which the physical conference space is reserved. Where a match is determined (i.e., where the name or other identity information of the person is identified within the video conference participant list), the system automatically checks the physical conference space in for the video conference; otherwise, the physical conference space remains unchecked-in for the video conference. In some cases, the user detection processes described herein may be limited to participants who have host or host-like privileges for the video conference to avoid others from checking in the physical conference space. Determination of a detected user's privileges for the video conference may be determined by the system accessing a record storing configuration information for the video conference.

In some implementations, the user detection processes described herein may be performed by, at, using, or otherwise in connection with a physical conference space device, referred to as a controller device, configured to facilitate video conferences from within the physical conference space. For example, the controller may execute an application programming interface (API) call for a motion sensor within the physical conference space to detect a person within the physical conference space. Responsive to detecting the person within the physical conference space, the controller device, by accessing a data store storing one of an authenticated image or an authenticated voiceprint, performs an identification operation to determine a name of the person. For example, the identification operation may include an image-based (e.g., facial recognition) or audio-based (e.g., speech recognition) process. The controller device determines, by accessing a conferencing server storing information associated with a video conference for which the physical conference space is reserved, whether the name of the person is included within a participant list for the video conference. Responsive to determining that the name of the person is included within the participant list, the controller device performs a check-in operation to indicate an in-use status of the physical conference space for the video conference.

In some examples of the present disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

For example, some implementations of this disclosure describe using a machine learning model for user detection (e.g., via facial recognition and/or for speech recognition) as part of the process for checking in a physical conference space. A machine learning model as used herein may be or include one or more of a neural network (e.g., a convolutional neural network, recurrent neural network, or other neural network), decision tree, vector machine, Bayesian network, genetic algorithm, deep learning system separate from a neural network, or other machine learning model. As will be described below in detail, the machine learning model is trained with appropriate authorization using a commercially available dataset and not using data or media of users of the systems and techniques disclosed herein or otherwise of a software platform that uses same. Furthermore, and as will also be described below in detail, the machine learning model is used to process data only for those users who have explicitly enrolled in, and thus provided authorization for, user detection as disclosed herein.

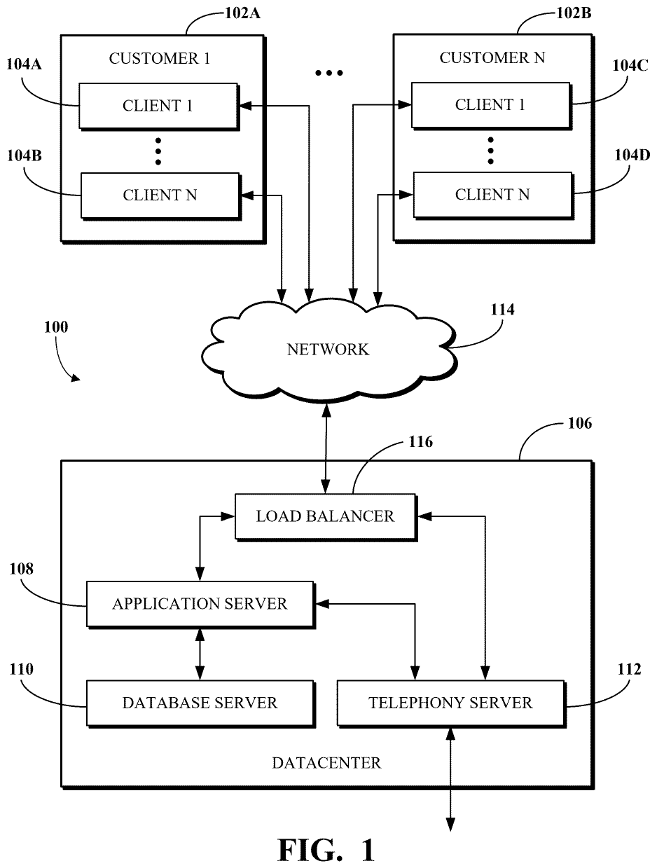

To describe some implementations in greater detail, reference is first made to examples of hardware and software structures used to implement a system for user detection for physical conference space check-in. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

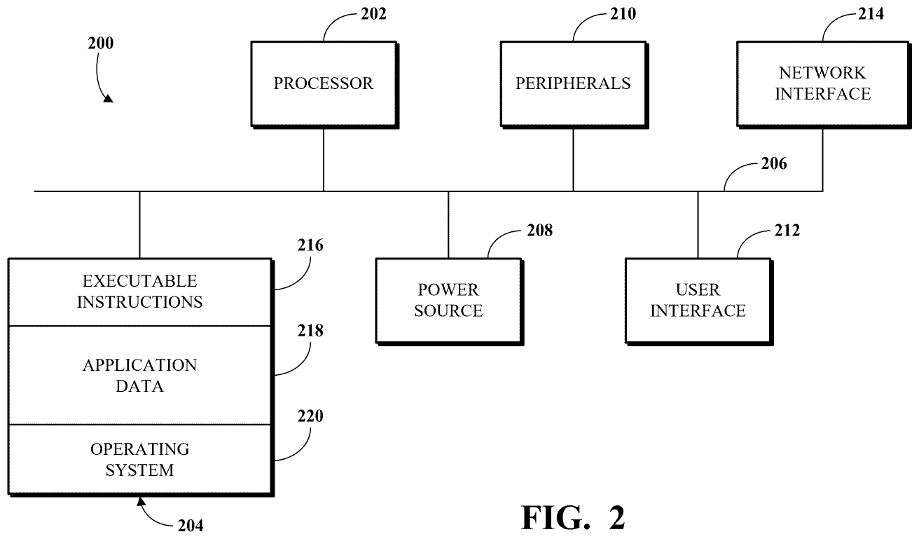

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

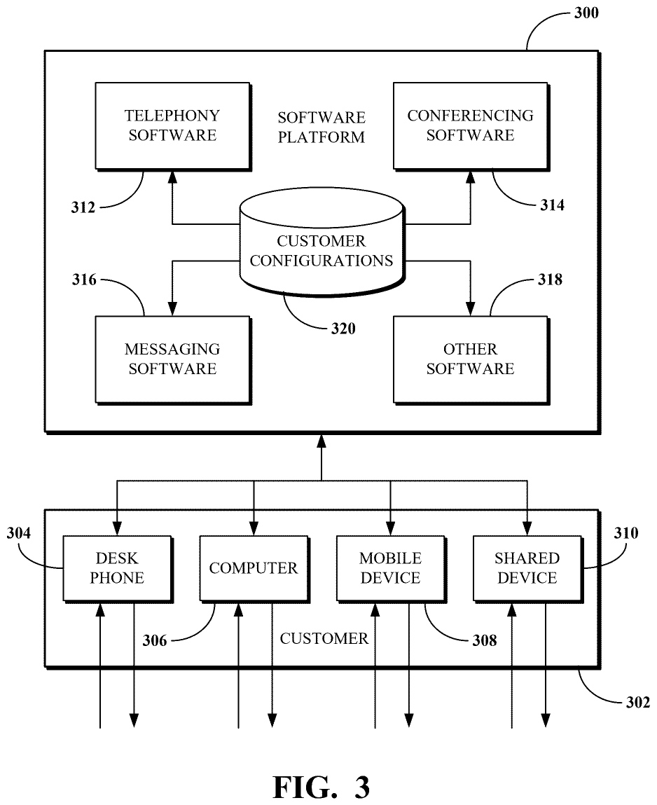

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include physical conference space check-in software. In some such cases, the conferencing software 314 can include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

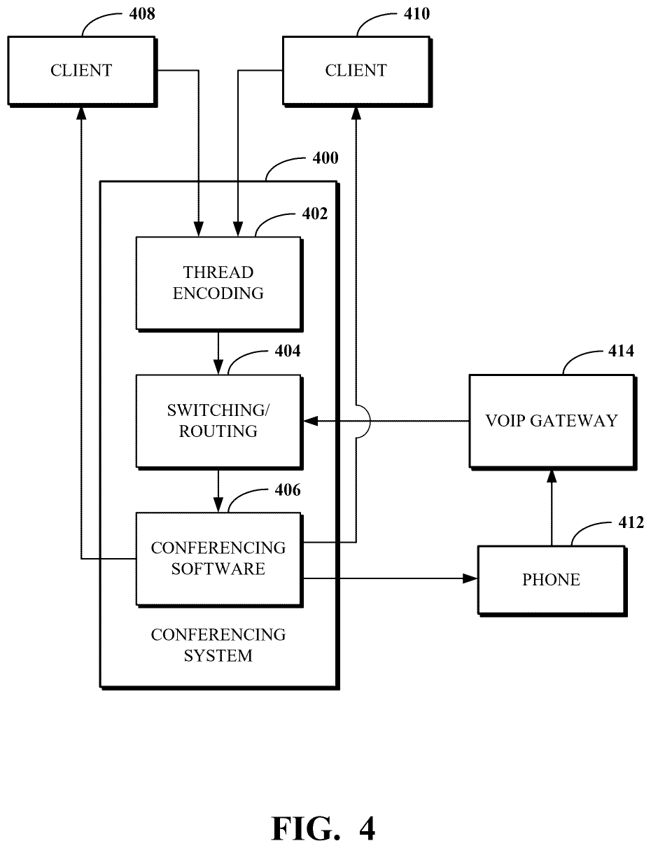

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may, in some examples, be one of a gallery view in which all user interface tiles are similarly or identically sized and arranged in a generally grid layout, a speaker view in which one or more user interface tiles for active speakers are enlarged and arranged in a center position of the conferencing software user interface while the user interface tiles for other conference participants are reduced in size and arranged near an edge of the conferencing software user interface, or a combined speaker and gallery view. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 direct the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

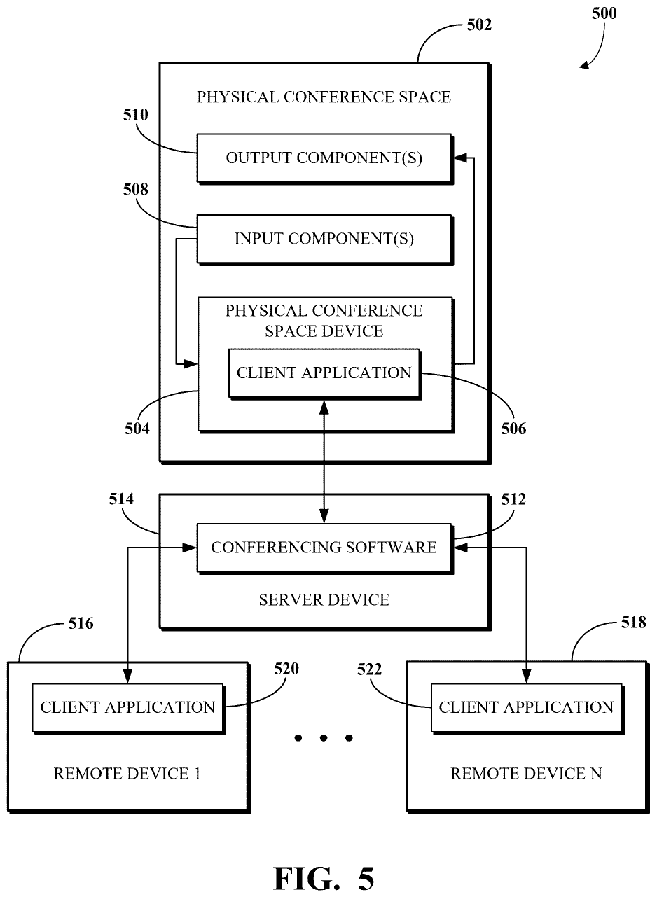

FIG. 5 is a block diagram of an example of a software-based room system 500 for conferencing software services, for example, the conferencing software services described with respect to FIGS. 3 and 4. The system 500 includes hardware and software components used to facilitate conferencing experiences within a physical conference space 502. The physical conference space 502 is an indoor or outdoor space within which one or more people may be physically located during some or all of a video conference. In one non-limiting example, the physical conference space 502 may be a conference room.

The physical conference space 502 includes a physical conference space device 504, also referred to herein as a controller device, which is a computing device that runs software including a client application 506 configured to connect the physical conference space device 504 to a video conference and otherwise facilitate video conferences from within the physical conference space 502. For example, the physical conference space device 504 may be a client such as one of the clients 304 through 310 shown in FIG. 3 (e.g., the shared device 310) or one of the clients 408 through 410 shown in FIG. 4. While the physical conference space device 504 is shown as being located within the physical conference space 502, in some implementations, the physical conference space device 504 may instead be located external to but remain associated with the physical conference space 502. The physical conference space 502 also includes one or more input components 508 and one or more output components 510 usable in connection with a video conference. The one or more input components 508 may, for example, include one or more cameras, microphones, or sensors. The one or more output components 510 may, for example, include one or more displays.

The video conference which the client application 506 connects the physical conference space device 504 to is implemented by conferencing software 512 running at a server device 514, which may, for example, be a server used with the conferencing system 400 shown in FIG. 4. For example, the server device 514 may be the application server 108 shown in FIG. 1. The conferencing software 512 may, for example, be the conferencing software 314 shown in FIG. 3. The video conference is a video-enabled conference with two or more participants in which one or more of those participants are in the physical conference space 502 and one or more of those participants are remote participants located external to the physical conference space 502.

As shown, the remote participants connect the video conference via remote devices 1 516 through N 518, in which N is an integer greater than or equal to 2. Each of the remote devices 1 516 through N 518 is a computing device and may, for example, be one of the clients 304 through 310 or one of the clients 408 through 410. Where a single remote device is connected to the video conference, the remote device N 518 (as well as any other remote device other than the remote device 1 516) is omitted. As shown, each of the remote devices 1 516 through N 518 runs a client application 520 through 522, which are software configured to communicate with the conferencing software 512 to enable the users of the remote devices 1 516 through N 518 to participate in the video conference implemented using the conferencing software 512 as remote participants.

The one or more input components 508 capture input (e.g., video data) that is then transmitted to the conferencing software 512 for rendering within a user interface tile of a user interface of the video conference. For example, an input video stream from the physical conference space device 504 may be processed and output within a user interface tile associated with the physical conference space 502, and thus with the conference participants located thereat. Similarly, the remote devices 1 516 through N 518 each include one or more capture components, such as a camera, which capture input (e.g., video data) that is then transmitted to the conferencing software 512 for rendering within a user interface tile of a user interface of the video conference. For example, an input video stream from the remote device 1 516 may be processed and output within a user interface tile associated with the remote participant using the remote device 1 516 within the user interface of the video conference and an input video stream from the remote device N 518 may be processed and output within a user interface tile associated with the remote participant using the remote device N 518 within the user interface of the video conference.

In some implementations, one or more of the devices connected to the conferencing software 512 can connect to the video conference implemented by the conferencing software 512 other than by using a client application, such as the client applications 506 and 520 through 522. For example, the physical conference space device 504 and/or one or more of the remote devices 1 516 through N 518 may connect to the video conference using a web application running through a web browser. In another example, the physical conference space device 504 and/or one or more of the remote devices 1 516 through N 518 may connect to the video conference using a software application other than a web browser or a client application, for example, a non-client desktop or mobile application.

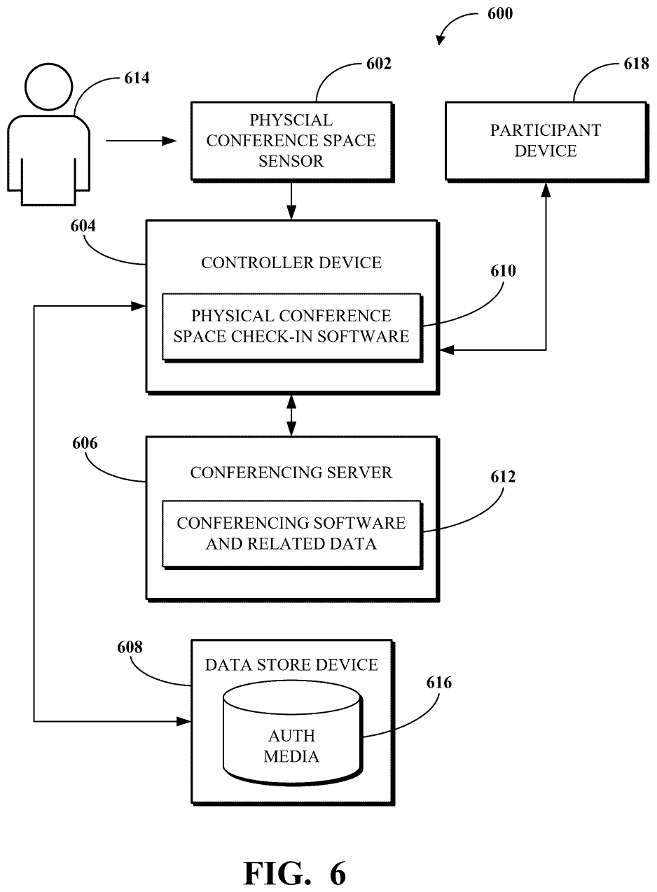

FIG. 6 is a block diagram of an example of a system 600 for user detection for physical conference space check-in. The system 600 is used with a video conference implemented by a conferencing system, for example, the conferencing system 400 shown in FIG. 4. For example, the system 600 can be used for a video conference involving a software-based room system, such as the software-based room system 500 shown in FIG. 5, to deliver content to devices connected to the video conference.

The system 600 includes a physical conference space sensor 602, a controller device 604, a conferencing server 606, and a data store device 608. The controller device 604, which may, for example, be the physical conference space device 504 shown in FIG. 5, is configured to facilitate video conferences from within a physical conference space, for example, the physical conference space 502 shown in FIG. 5. For example, the controller device 604, to initiate a video conference from the physical conference space (e.g., based on user input obtained at the controller device 604, user input provided to a different computing device, or an automated determination via the conferencing server 606), the controller device 604 opens a channel with the conferencing server 606 and begins communicating participant media streams between it and the conferencing server 606 to transmit its own audiovisual signal and obtain the audiovisual signal of one or more participant devices connected to the video conference. The conferencing server 606 may thus, for example, be the server device 514 shown in FIG. 5.

The physical conference space sensor 602 is a wired or wireless sensor in communication with software running at the controller device 604 and is configured to generate output usable to detect a person within the physical conference space. For example, the physical conference space sensor 602 may be a motion sensor, an infrared sensor, a camera, a microphone, a thermal sensor, or the like, or a combination thereof. For example, the output generated by the physical conference space sensor 602 may indicate a binary determination that one or more people are present in the physical conference space or a count of people who are present in the physical conference space. In some cases, the physical conference space sensor 602 may be or include (or be included in) a computing device that obtains user input within the physical space, for example, a whiteboard device, and the output may be generated as a binary indicator that such user input is obtained. In some cases, multiple physical conference space sensors 602 may be used.

The controller device 604 includes (i.e., executes, interprets, or otherwise runs) physical conference space check-in software 610. The physical conference space check-in software 610 performs various functionality related to determining whether to check-in the physical conference space for a video conference based on output obtained by the controller device 604 from the physical conference space sensor 602 and to checking-in or not checking-in the physical conference space accordingly. The controller device 604 interfaces with the conferencing server 606 and the data store device 608 to facilitate the operations performed by or otherwise using the physical conference space check-in software 610.

For example, the controller device 604, via the physical conference space check-in software 610, may communicate with the conferencing server 606 to determine, based on a participant list obtained via conferencing software and related data 612 at the conferencing server 606 (e.g., the conferencing software 512 shown in FIG. 5 and data used in connection therewith), whether a person 614 detected using the output of the physical space conference sensor 602 is included within a participant list for a video conference for which the physical conference space is reserved for use. For example, the related data of the conferencing software and related data 612 may include data associated with a video conference of which the physical conference space is reserved and data associated with participants who have been invited to attend the video conference (e.g., a participant list).

In another example, the controller device 604, via the physical conference space check-in software 610, may communicate with the data store device 608 to obtain authenticated media associated the person 614. The data store device 608 is a server configured to host a data store 616 within which various authenticated media uploaded for use for checking in the physical conference space or otherwise for video conferencing may be stored. For example, the data store device 608 may be the database server 110 shown in FIG. 1. In some implementations, the data store device 608 may be the conferencing server 606. For example, the conferencing server 606 may include (e.g., execute, interpret, or otherwise run) the conferencing software 616 and store the related data and the data store 616.

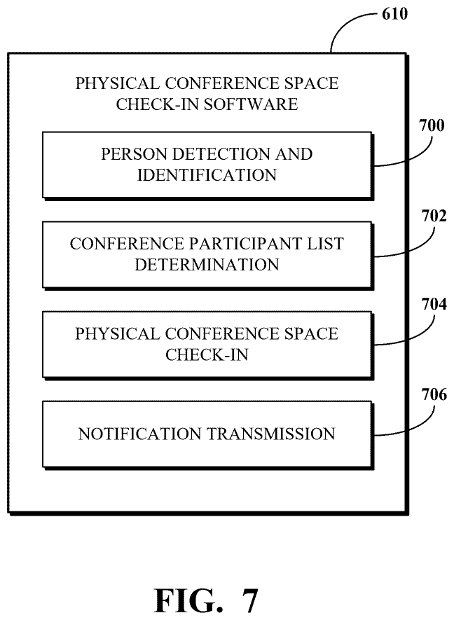

To further describe the physical conference space check-in software 610, reference is made to FIG. 7, which is a block diagram of example functionality of the physical conference space check-in software 610. The physical conference space check-in software 610 includes tools, such as programs, subprograms, functions, routines, subroutines, operations, and/or the like for message-based task determination. As shown, the physical conference space check-in software 610 includes a person detection and identification tool 700, a conference participant list determination tool 702, a physical conference space check-in tool 704, and a notification transmission tool 706.

The person detection and identification tool 700 performs person detection and person identification. Person detection includes detecting a person (e.g., the person 614) within the physical conference space and person identification includes performing an identification operation to determine the name of the person. To perform person detection, the person detection and identification tool 700 obtains and processes output generated by the physical conference space sensor 602 to detect the person 614 within the physical conference space. For example, the person detection and identification tool 700 may execute an API call for the physical conference space sensor 602 to cause the physical conference space sensor 602 to generate and/or transmit output usable by the person detection and identification tool 700 to detect the person 614. For example, where the physical conference space sensor 602 is a motion sensor, the controller device 604, via the person detection and identification tool 700, may execute (or otherwise cause an execution of) an API call for the motion sensor to obtain output of the motion sensor and thus detect, based on such output, the person 614 within the physical conference space. In some implementations, the person detection and identification tool 700 may not execute an API call (or otherwise cause such execution) and the physical conference space sensor 602 may instead transmit its output to the controller device 604 for processing by the person detection and identification tool 700 independent of an API call executed by the person detection and identification tool 700.

To perform person identification, the person detection and identification tool 700, responsive to detecting the person 614 within the physical conference space, accesses (i.e., via a network interface of the controller device 604) the data store 616 to obtain authenticated media and performs an identification operation to determine the name of the person 614 based on the authenticated media. For example, the authenticated media may be an authenticated image or an authenticated voiceprint. The quality of an image or voiceprint being authenticated refers to the storage of the image or voiceprint in connection with a consent process performed in connection with the image or voiceprint. In particular, prior to the performance of the identification operation, the person 614 may enroll in a process for the system 600 to identify participants of video conferences before or during those video conferences. Such enrollment includes the person 614 providing their image or voiceprint and consenting to the use of their image or voiceprint to identify them before or during a video conference. Such consent may later be revoked.

The identification operation includes, based on whether the authenticated media obtained by accessing the data store 616 is an image or voiceprint, determining that the authenticated media corresponds to the person detected within the physical conference space. While images and voiceprints are described throughout the implementations of this disclosure as the authenticated media used for person identification, in some implementations, other types of authenticated media may be used.

For example, where an authenticated image is obtained, performing the identification operation to determine the name of the person 614 can include obtaining the authenticated image from the data store, causing a camera within the physical conference space to capture a new image of the person 614, performing facial recognition to determine a match of features within the authenticated image and the new image (i.e., matching features within the authenticated image and the new image), and determining the name of the person 614 based on the match of the features. For example, determining the name of the person 614 based on the match can include accessing the data store 616 to determine a name associated with a record of the authenticated image within the data store 616 and determining that the name is the name of the detected person 614 based on the match of features described above. Thus, the identification operation may be or include a facial recognition process and performing the facial recognition process may include determining a match between features of an image depicting the detected person 614 and features of an image from a camera and then obtaining the name information from a data store based on the match.

In another example, where an authenticated voiceprint is obtained, performing the identification operation to determine the name of the person 614 can include obtaining the authenticated voiceprint from the data store, causing a microphone within the physical conference space to capture a new voiceprint of the person 614, performing speech recognition to determine a match of features within the authenticated voiceprint and the new voiceprint (i.e., matching features within the authenticated voiceprint and the new voiceprint), and determining the name of the person 614 based on the match of the features. For example, determining the name of the person 614 based on the match can include accessing the data store 616 to determine a name associated with a record of the authenticated voiceprint within the data store 616 and determining that the name is the name of the detected person 614 based on the match of features described above. Thus, the identification operation may be or include a speech recognition process and performing the speech recognition process may include determining a match between features of a voiceprint representing speech of the detected person 614 and features of a voiceprint captured within an audio signal at the physical conference space and then obtaining the name information from a data store based on the match.

The conference participant list determination tool 702 determines whether the name of the person 614 as identified by the person detection and identification tool 700 is included within a participant list for a video conference for which the physical conference space is reserved for use. The conference participant list determination tool 702 determines whether the name of the person 614 is included within the participant list by accessing, via a network interface of the conference participant list determination tool 702, the conferencing server 606 storing information associated with the video conference (e.g., the data stored relative to the conferencing software 612). Thus, the controller device 604, via the conference participant list determination tool 702, may access a participant list for the video conference and determine whether the name of the person 614 is included within that participant list.

The physical conference space check-in tool 704 determines whether to perform a check-in operation to indicate an in-use status of the physical conference space for the video conference based on whether the name of the person 614 is included within the participant list for the video conference and performs the check-in operation in applicable situations. The check-in operation is, includes, or otherwise refers to one or more functions for causing the physical conference space to have an in-use status, which may be indicated to one or more users or potential users of the system 600. For example, performing the check-in operation may include causing reservation software used to make a reservation for the physical conference space for the video conference to indicate the status of the physical conference space as “in-use” to prevent reservation requests from being processed or otherwise accepted during a time period wholly or partially overlapping a time period of the subject video conference for which it is reserved. The physical conference space check-in tool 704 determines to perform the check-in operation based on a determination by the conference participant list determination tool 702 that the name of the person 614 is included within the participant list for the video conference. The physical conference space check-in tool 704 determines to not perform the check-in operation based on a determination by the conference participant list determination tool 702 that the name of the person 614 is not included within the participant list for the video conference.

The notification transmission tool 706 transmits a notification of the check-in or otherwise of the in-use status of the physical conference space to one or more computing devices. For example, the one or more computing devices may include one or more of a client device used by or otherwise associated with a host or non-host participant of the video conference (e.g., a participant device 618 as shown in FIG. 6, which may, for example, be one of the clients 304 through 310 shown in FIG. 3), a server used for facilitating the video conference (e.g., the conferencing server 606), a digital signage device used in connection with the physical conference space (e.g., a digital nameplate or like sign usable to changeably indicate information associated with the physical conference space), or the like, or a combination thereof. The notification may take one or more forms depending on the device to which it is transmitted. For example, where the notification is transmitted to the participant device 618, the notification may be one of a push notification associated with a client application installed at the participant device 618 and used to enable a user of the participant device 618 to participate in video conferences and/or other synchronous or asynchronous communications, a chat message transmitted within the client application, or a text message (e.g., a short message service (SMS) message, a multimedia messaging service (MMS) message, or a rich communication services (RCS) message). In another example, where the notification is transmitted to the conferencing server 606, the notification may include data usable to cause the conferencing server to initiate or prepare to initiate the video conference.

The tools 700 through 706 are shown by example. As such, in some implementations, the physical conference space check-in software 610 may include one or more other tools in addition to and/or in place of one or more of the tools 700 through 706. Moreover, while the tools 700 through 706 are shown and described as being part of the physical conference space check-in software 610 at the controller device 604, in some implementations, the physical conference space check-in software 610 or otherwise one or more of the tools 700 through 706 may instead be included elsewhere, for example, the conferencing server 606 or another computing device of or otherwise usable in connection with the system 600.

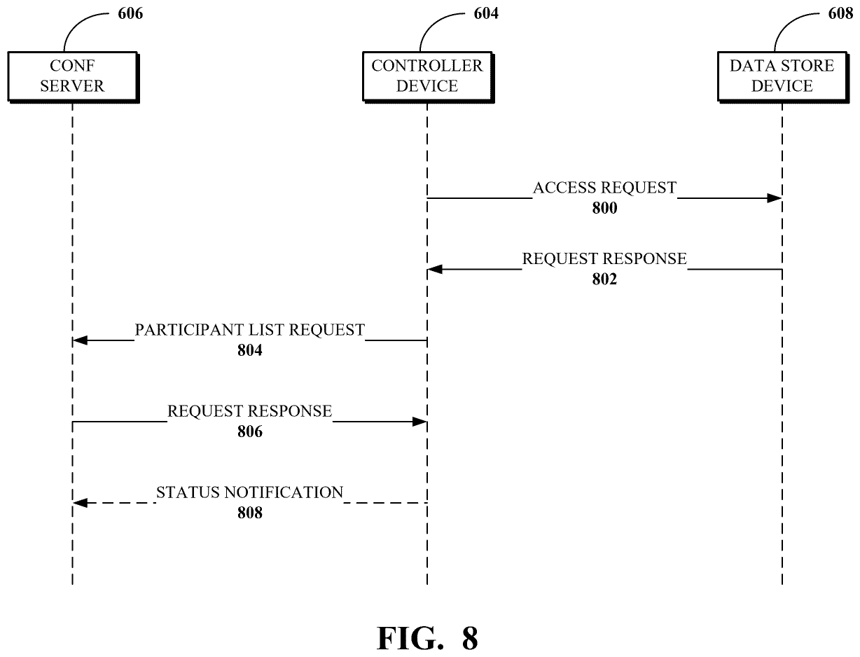

FIG. 8 is a swim lane diagram of an example of a user detection process performed to check-in a physical conference space, for example, the physical conference space 502 shown in FIG. 5. As shown, the swim lane diagram illustrates operations performed by, using, or otherwise in connection with the controller device 604, the conferencing server 606, and the data store device 608 shown in FIG. 6.

An access request 800 is transmitted from the controller device 604 to the data store device 608. The access request is a request to access a data store stored at the data store device 608 (e.g., the data store 616 shown in FIG. 6) to obtain (e.g., retrieve, such as via a pull operation by the controller device 604, or receive, such as via a push operation by the data store device 608) authenticated media associated with a person detected within the physical conference space.

A request response 802 is transmitted from the data store device 608 to the controller device 604 in response to the access request 800. The request response 802 may include an acceptance of the access request 800 or a denial of the access request 800. In some cases, where the access request 800 is accepted, the request response 802 may also include the authenticated media associated with the person detected within the physical conference space. In other cases, where the access request 800 is accepted, the request response 802 may include data or like content usable by the controller device 604 to then retrieve or receive the authenticated media.

Where the access request 800 is accepted via the request response 802, a participant list request 804 is transmitted by the controller device 604 to the conferencing server 606. The participant list request 804 is a request for a participant list of a video conference for which the physical conference space is reserved. The conferencing server 606 maintains the participant list in connection with a record of the video conference. The participant list includes names of people who have accepted an invitation for the video conference and thus will join the video conference as participants, whether or not they have host privileges. In some cases, the participant list may also include names of people to whom an invitation for the video conference has been sent but who have not yet accepted or rejected the invitation, considering them as potential participants of the video conference.

A request response 806 is transmitted by the conferencing server 606 to the controller device 604 in response to the participant list request 804. The request response 806 may include an acceptance of the participant list request 804 or a denial of the participant list request 804. In some cases, where the participant list request 804 is accepted, the request response 806 may also include the participant list. In other cases, where the participant list request 804 is accepted, the request response 806 may include data or like content usable by the controller device 604 to then retrieve or receive the participant list.

Where the participant list request 804 is accepted via the request response 806 and the controller device 604 determines (e.g., via the conference participant list determination tool 702 shown in FIG. 7) that the name of the person detected within the physical conference space is included within the participant list for the video conference, a status notification 808 may in some cases be transmitted by the controller device 604 to the conferencing server 606 to indicate an in-use status of the physical conference space to the conferencing server 606. For example, the conferencing server 606 may in some cases use the status notification 808 to initiate the video conference.

The swim lane diagram of FIG. 8 illustrates an approach in which the controller device 604 performs the functionality described with respect to the physical conference space check-in software 610 shown in FIGS. 6 and 7. In some implementations, where the functionality described with respect to the physical conference space check-in software 610 is performed other than at the controller device 604, the swim lane diagram may be modified to show a different sequence of operations involving the devices 604 through 608 and/or one or more other devices.

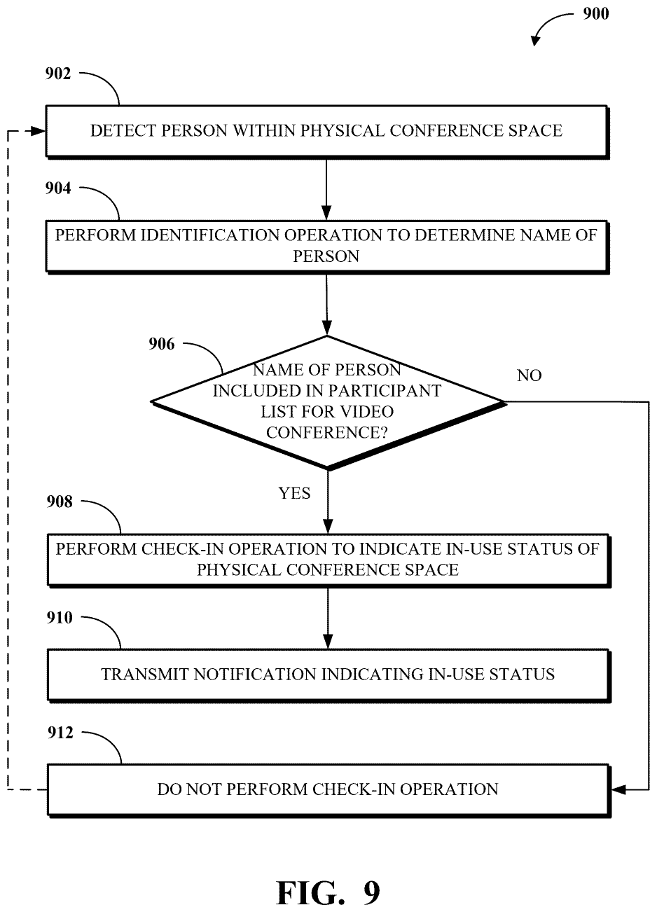

To further describe some implementations in greater detail, reference is next made to examples of techniques which may be performed by or using a system for user detection for physical conference space check-in. FIG. 9 is a flowchart of an example of a technique 900 for user detection for physical conference space check-in. The technique 900 can be executed using computing devices, such as the systems, hardware, and software described with respect to FIGS. 1-8. The technique 900 can be performed, for example, by executing a machine-readable program or other computer-executable instructions, such as routines, instructions, programs, or other code. The steps, or operations, of the technique 900, or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations of the technique 900 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 902, a person is detected within a physical conference space. Detecting the person within the physical conference space includes one or more sensors within or otherwise of the physical conference space generating output indicative of measurements captured using the one or more sensors and using that output to determine that a person is located in the physical conference space. For example, detecting the person within the physical conference space can include a controller device configured to facilitate video conferences from within the physical conference space executing an API call for a sensor (e.g., a motion sensor) within the physical conference space to detect the person within the physical conference space. In another example, detecting the person within the physical conference space can include detecting the person within the physical conference space using output of the sensor and output of one or more other sensors or devices within the physical conference space. In some cases, the sensor may generate and provide its output for processing by the controller device without an API call. In some cases, the sensor may generate and provide its output for processing by the controller device based on user input indicating to initiate a check-in process. For example, such user input may be obtained via the controller device. Regardless of whether an API call is executed, the sensor output is obtained during a period of time corresponding to the reservation of the physical conference space for the video conference. The period of time may, for example, be, include, or otherwise refer to a time buffer prior to a scheduled start time of the video conference. For example, sensor output obtained prior to the period of time may be discarded and not used to detect a person within the physical conference space.

At 904, an identification operation is performed to determine a name of the person detected within the physical conference space. The identification operation is performed responsive to detecting the person within the physical conference space. In particular, the identification operation is performed by the controller device accessing a data store storing authenticated media associated with the person, for example, one of an authenticated image or an authenticated voiceprint. For example, where an authenticated image is used, performing the identification operation to determine the name of the person can include obtaining the authenticated image from the data store, causing a camera within the physical conference space to capture a new image of the person, performing facial recognition to determine a match of features within the authenticated image and the new image, and determining the name of the person based on the match of the features. In another example, where an authenticated voiceprint is used, performing the identification operation to determine the name of the person can include obtaining the authenticated voiceprint from the data store, causing a microphone within the physical conference space to capture a new voiceprint of the person, performing speech recognition to determine a match of features within the authenticated voiceprint and the new voiceprint, and determining the name of the person based on the match of the features.

In some implementations, the identification operation may be performed independent of authenticated media associated with the detected person. For example, the identification operation may be performed based on a device of the detected person. In some such implementations, performing the identification operation to identify the name of the person detected within the physical conference space can include identifying a device pairing between a participant device of the person and the controller device and using the device pairing to determine the name of the person.

At 906, a determination is made as to whether the name of the person is included within a participant list for a video conference for which the physical conference space is reserved. Determining whether the name of the person is included within the participant list for the video conference includes the controller device accessing a conferencing server storing information associated with the video conference. For example, the conferencing server may maintain a list of all persons invited to the video conference who have accepted the invitation and, in some cases, a list of all persons invited to the video conference who have not yet accepted or decline the invitation as of a given time. The access of the conferencing server enables a retrieval or receipt of this participant information by the controller device. The determination as to whether the participant list includes the name of the person is then made by software running at the controller device comparing the name of the person against name identifier or like field information within the participant list to determine whether a match is found.

At 908, responsive to a determination that the name of the person is included within the participant list, a check-in operation is performed to indicate an in-use status of the physical conference space. The controller device performs the check-in operation to cause the status of the physical conference space to be indicated as in-use in one or more system interfaces. For example, software running at the controller device may transmit data or a like signal to a server used for workspace reservation (e.g., to manage and enable reservations of spaces such as and including the physical conference space) to indicate that a reservation made for the physical conference space (i.e., in connection with or independent of the video conference) is in progress and thus that the physical conference space is in-use. This status indication is configured to cause the workspace reservation system to prevent a further reservation of the physical conference space for a period of time partially or wholly overlapping that of the reservation for the video conference.

At 910, a notification indicating the in-use status of the physical conference space is transmitted to one or more computing devices. For example, the controller device may transmit one or more notifications to one or more computing devices or otherwise cause such transmissions. The one or more computing devices may include participant (e.g., client) devices usable to access the video conference, a server which hosts the video conference or otherwise enables the communication of media streams between participants thereof, a digital signage display associated with the physical conference space (e.g., on an external wall surface of the physical conference space or otherwise in an office or suite within which the physical conference space is located) or another computing device located within or external to the physical conference space. For example, transmitting the notification can include transmitting a notification to one or more user devices associated with one or more participants included within the participant list to indicate the in-use status of the physical conference space for the video conference. In another example, transmitting the notification can include transmitting a notification to one or more user devices associated with one or more participants included within the participant list to indicate that the person, identified by the name of the person, is detected within the physical conference space. In yet another example, transmitting the notification can include indicating, or otherwise causing an indication of, one or both of the in-use status of the physical conference space for the video conference or the name of the person within a digital signage display located outside of the physical conference space.

At 912, responsive to a determination that the name of the person is not included within the participant list, the check-in operation is not performed. In such a case, the person detected within the physical conference space is considered to not be someone related to the video conference for which the physical conference space is reserved, and so the physical conference space is not checked-in. In some implementations, however, responsive to a determination that the name of the person is not included within the participant list, a temporary check-in may instead be performed to a indicate temporary use of the physical conference space pending a check-in in connection with the video conference. In some such implementations, a notification may be transmitted to one or more participant devices associated with the video conference (e.g., a device of a host) to indicate the temporary check-in. In some such implementations, a message may be displayed on an output device located within the physical conference space to indicate the temporary check-in to the person detected within the physical conference space. For example, the indication can be output within a display of the physical conference space alongside a message indicating the actual reservation. In some implementations, a temporary check-in as described herein may be delayed until an expiration of a threshold wait period (e.g., fifteen minutes) to determine whether the detected person is merely present within the physical conference space for a trivial period of time. In some implementations, a temporary check-in as described herein may be prevented where a determination is made that the participant list of the video conference includes a priority participant (e.g., a C-level officer or executive of an entity or other very important person).

In some implementations, after a determination to not perform the check-in operation (e.g., because the name of the person detected within the physical conference space is not included within the participant list of the video conference for which the physical conference space is reserved), the technique 900 may return to 902. For example, a system configuration may automatically cause the sensor within the physical conference space to generate new sensor output on an event-basis (e.g., upon a new detection of a person) or a periodic basis (e.g., once every fifteen seconds). In some such implementations, where the same person is detected within the physical conference space, some or all of the rest of the technique 900 may be omitted. For example, in connection with a decision to not perform the check-in operation, information (e.g., a name, image, or voiceprint) associated with the detected person may be cached or buffered at the controller device and used to readily determine that the same person has again been detected and thus a same determination to not perform the check-in operation should be made. Thus, the technique 900 may, in some implementations, include determining whether information associated with the detected person is stored within a cache or buffer of the controller device and determining not to perform the check-in operation responsive to a determination that the information associated with the detected person is stored within a cache or buffer of the controller device.

In some implementations, performing the check-in operation can include performing a check-in operation to initiate the video conference. For example, the check-in operation may itself include initiating the video conference or otherwise causing such initiation. In another example, the initiation of the video conference may be part of an operation separate from the check-in operation. In some implementations, the technique 900 can include determining whether a mobile device associated with the person detected within the physical conference space is already connected to the video conference based on a telephone number used by the mobile device. For example, in connection with the access of the conferencing server to obtain the participant list, the controller device can determine whether the video conference is already active and whether a telephone number associated with the detected person is already connected to the video conference. For example, an association between a telephone number and a person can be determined by the controller device accessing a data store storing records of user devices.

In some implementations, the technique 900 may include operations performed at an end of the video conference. For example, the controller device at a time after a completion of the video conference may execute an API call to the sensor within the physical conference space to detect, based on output generated by the sensor based on that API call, that no persons remain within the physical conference space. Detecting that no persons remain within the physical conference space may, for example, include using sensor output to determine that no motion or speech audio is detected within the physical conference space. Responsive to detecting that no persons remain within the physical conference space, the controller device may perform a check-out operation to indicate an available status of the physical conference space. In some cases, the sensor may generate and provide its output for processing by the controller device without an API call.

In some implementations, the technique 900 may include operations to authenticate the person detected within the physical conference space beyond determining whether their name is included within the participant list of the video conference. For example, a configuration may indicate that the video conference is associated with sensitive information. The controller device may, based on that configuration, perform an authentication process to determine that the person is authenticated for the video conference. For example, performing the authentication process may include determining whether the detected person has host privileges for the video conference. Where a determination is made that the detected person has host privileges, they may be authenticated; otherwise, where a determination is made that the detected person does not have host privileges, a request to authenticate the detected person may be transmitted to a device associated with a host of the video conference. The authentication of the detected person may then be based on a response to that authentication request.

In some implementations, the name of the person may be provided to the conferencing server to include the name of the person within the video conference or otherwise use the name of the person in connection with the video conference. For example, the name of the person may be communicated to the conferencing server alongside an image of the person. During the video conference, the image of the person may be used (e.g., as part of a facial recognition process) to identify the person, and the name of the person, based on such identification, may be then be output in one or more user interfaces of the video conference, for example, to identify the person to other participants of the video conference.

In some implementations, the technique 900 may be performed independent of a video conference or otherwise of a reservation of the physical conference space for a video conference. For example, the reservation of the physical conference space may be a purpose unrelated to a video conference, such as an in-person meeting between people who will all be physically present within the physical conference space. In some such implementations, the technique 900 may be performed to detect the person, identify the name of the person, determine that the physical conference space is available, check-in the physical conference space for user by the person, and transmit a notification indicating the in-use status of the physical conference space, all as described above but independent of a video conference.

The implementations of this disclosure describe methods, systems, devices, apparatuses, and non-transitory computer readable media for user detection for physical conference space check-in. In some implementations, a method comprises, a non-transitory computer readable medium stores instructions operable to cause one or more processors to perform operations comprising, and/or a system comprises a memory subsystem storing instructions and processing circuitry configured to execute the instructions for: executing, by a controller device configured to facilitate video conferences from within a physical conference space, an application programming interface call for a motion sensor within the physical conference space to detect a person within the physical conference space; responsive to detecting the person within the physical conference space, performing, by the controller device accessing a data store storing one of an authenticated image or an authenticated voiceprint, an identification operation to determine a name of the person; determining, by the controller device accessing a conferencing server storing information associated with a video conference for which the physical conference space is reserved, whether the name of the person is included within a participant list for the video conference; and responsive to determining that the name of the person is included within the participant list, performing, by the controller device, a check-in operation to indicate an in-use status of the physical conference space for the video conference.

In some implementations of the method, the non-transitory computer readable medium, and/or the system, performing the identification operation to determine the name of the person comprises: obtaining the authenticated image from the data store; causing a camera within the physical conference space to capture a new image of the person; matching features within the authenticated image and the new image; and determining the name of the person based on the match of the features.

In some implementations of the method, the non-transitory computer readable medium, and/or the system, performing the identification operation to determine the name of the person comprises: obtaining the authenticated voiceprint from the data store; causing a microphone within the physical conference space to capture a new voiceprint of the person; matching features within the authenticated voiceprint and the new voiceprint; and determining the name of the person based on the match of the features.

In some implementations of the method, the non-transitory computer readable medium, and/or the system, executing the application programming interface call for the motion sensor within the physical conference space to detect the person within the physical conference space comprises: detecting the person within the physical conference space using output of the motion sensor and output of one or more other sensors or devices within the physical conference space.

In some implementations of the method, the non-transitory computer readable medium, and/or the system, the method comprises, the operations comprise, and/or the processing circuitry is configured to execute the instructions for: transmitting a notification to one or more user devices associated with one or more participants included within the participant list to indicate the in-use status of the physical conference space for the video conference.

In some implementations of the method, the non-transitory computer readable medium, and/or the system, the method comprises, the operations comprise, and/or the processing circuitry is configured to execute the instructions for: transmitting a notification to one or more user devices associated with one or more participants included within the participant list to indicate that the person, identified by the name of the person, is detected within the physical conference space.

In some implementations of the method, the non-transitory computer readable medium, and/or the system, the method comprises, the operations comprise, and/or the processing circuitry is configured to execute the instructions for: indicating one or both of the in-use status of the physical conference space for the video conference or the name of the person within a digital signage display located outside of the physical conference space.

In some implementations of the method, the non-transitory computer readable medium, and/or the system, the method comprises, the operations comprise, and/or the processing circuitry is configured to execute the instructions for: determining whether a mobile device associated with the person is already connected to the video conference based on a telephone number used by the mobile device.

In some implementations of the method, the non-transitory computer readable medium, and/or the system, the method comprises, the operations comprise, and/or the processing circuitry is configured to execute the instructions for: executing, by the controller device at a time after a completion of the video conference, the application programming interface call for the motion sensor to detect that no persons remain within the physical conference space; and responsive to detecting that no persons remain within the physical conference space, performing, by the controller device, a check-out operation to indicate an available status of the physical conference space.

In some implementations of the method, the non-transitory computer readable medium, and/or the system, the method comprises, the operations comprise, and/or the processing circuitry is configured to execute the instructions for: performing, by the controller device based on a configuration indicating that the video conference is associated with sensitive information, an authentication process to determine that the person is authenticated for the video conference.

In some implementations of the method, the non-transitory computer readable medium, and/or the system, where the authenticated image is obtained, a match of first features within the authenticated image and a new image of the person is determined and the name of the person is determined based on the match of the first features, and where the authenticated voiceprint is obtained, a match of second features within the authenticated voiceprint and a new voiceprint of the person is determined and the name of the person is determined based on the match of the second features.

In some implementations of the method, the non-transitory computer readable medium, and/or the system, the method comprises, the operations comprise, and/or the processing circuitry is configured to execute the instructions for: transmitting a notification indicating the in-use status of the physical conference space to one or more computing devices.

In some implementations of the method, the non-transitory computer readable medium, and/or the system, the person is detected using output of the motion sensor and output of another sensor or other device within the physical conference space.

In some implementations of the method, the non-transitory computer readable medium, and/or the system, the identification operation includes matching features using the authenticated image or using the authenticated voiceprint.

In some implementations of the method, the non-transitory computer readable medium, and/or the system, the video conference is initiated in connection with the check-in operation.

In some implementations of the method, the non-transitory computer readable medium, and/or the system, the person is detected using output of the motion sensor and output of one or more other sensors or devices.

In some implementations of the method, the non-transitory computer readable medium, and/or the system, a notification is transmitted to one or more computing devices to indicate the in-use status of the physical conference space.

In some implementations of the method, the non-transitory computer readable medium, and/or the system, a check-out operation is performed to indicate an available status of the physical conference space at an end of the video conference.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
executing, by a controller device configured to facilitate video conferences from within a physical conference space, an application programming interface call for a motion sensor within the physical conference space to detect a person within the physical conference space;
responsive to detecting the person within the physical conference space, performing, by the controller device accessing a data store storing one of an authenticated image or an authenticated voiceprint, an identification operation to determine a name of the person;
determining, by the controller device accessing a conferencing server storing information associated with a video conference for which the physical conference space is reserved, whether the name of the person is included within a participant list for the video conference; and
responsive to determining that the name of the person is included within the participant list, performing, by the controller device, a check-in operation to indicate an in-use status of the physical conference space for the video conference.

2. The method of claim 1, wherein performing the identification operation to determine the name of the person comprises:
obtaining the authenticated image from the data store;
causing a camera within the physical conference space to capture a new image of the person;
matching features within the authenticated image and the new image; and
determining the name of the person based on the match of the features.

3. The method of claim 1, wherein performing the identification operation to determine the name of the person comprises:
obtaining the authenticated voiceprint from the data store;
causing a microphone within the physical conference space to capture a new voiceprint of the person;
matching features within the authenticated voiceprint and the new voiceprint; and
determining the name of the person based on the match of the features.

4. The method of claim 1, wherein executing the application programming interface call for the motion sensor within the physical conference space to detect the person within the physical conference space comprises:
detecting the person within the physical conference space using output of the motion sensor and output of one or more other sensors or devices within the physical conference space.

5. The method of claim 1, comprising:
transmitting a notification to one or more user devices associated with one or more participants included within the participant list to indicate the in-use status of the physical conference space for the video conference.

6. The method of claim 1, comprising:
transmitting a notification to one or more user devices associated with one or more participants included within the participant list to indicate that the person, identified by the name of the person, is detected within the physical conference space.

7. The method of claim 1, comprising:
indicating one or both of the in-use status of the physical conference space for the video conference or the name of the person within a digital signage display located outside of the physical conference space.

8. The method of claim 1, comprising:
determining whether a mobile device associated with the person is already connected to the video conference based on a telephone number used by the mobile device.

9. The method of claim 1, comprising:
executing, by the controller device at a time after a completion of the video conference, the application programming interface call for the motion sensor to detect that no persons remain within the physical conference space; and
responsive to detecting that no persons remain within the physical conference space, performing, by the controller device, a check-out operation to indicate an available status of the physical conference space.

10. The method of claim 1, comprising:
performing, by the controller device based on a configuration indicating that the video conference is associated with sensitive information, an authentication process to determine that the person is authenticated for the video conference.

11. A non-transitory computer readable medium storing instructions operable to cause one or more processors to perform operations comprising:
executing, by a controller device configured to facilitate video conferences from within a physical conference space, an application programming interface call for a motion sensor within the physical conference space to detect a person within the physical conference space;
responsive to detecting the person within the physical conference space, performing, by the controller device accessing a data store storing one of an authenticated image or an authenticated voiceprint, an identification operation to determine a name of the person;
determining, by the controller device accessing a conferencing server storing information associated with a video conference for which the physical conference space is reserved, whether the name of the person is included within a participant list for the video conference; and
responsive to determining that the name of the person is included within the participant list, performing, by the controller device, a check-in operation to indicate an in-use status of the physical conference space for the video conference.

12. The non-transitory computer readable medium of claim 11, wherein, where the authenticated image is obtained, a match of first features within the authenticated image and a new image of the person is determined and the name of the person is determined based on the match of the first features, and
where the authenticated voiceprint is obtained, a match of second features within the authenticated voiceprint and a new voiceprint of the person is determined and the name of the person is determined based on the match of the second features.

13. The non-transitory computer readable medium of claim 11, the operations comprising:
transmitting a notification indicating the in-use status of the physical conference space to one or more computing devices.

14. The non-transitory computer readable medium of claim 11, wherein the person is detected using output of the motion sensor and output of another sensor or other device within the physical conference space.

15. A system, comprising:
a memory subsystem storing instructions; and
processing circuitry configured to execute the instructions to:
execute an application programming interface call for a motion sensor within a physical conference space to detect a person within the physical conference space;
responsive to detecting the person within the physical conference space, perform, by accessing a data store storing one of an authenticated image or an authenticated voiceprint, an identification operation to determine a name of the person;
determine, by accessing a conferencing server storing information associated with a video conference for which the physical conference space is reserved, whether the name of the person is included within a participant list for the video conference; and
responsive to a determination that the name of the person is included within the participant list, performing a check-in operation to indicate an in-use status of the physical conference space for the video conference.

16. The system of claim 15, wherein the identification operation includes matching features using the authenticated image or using the authenticated voiceprint.

17. The system of claim 15, wherein the video conference is initiated in connection with the check-in operation.

18. The system of claim 15, wherein the person is detected using output of the motion sensor and output of one or more other sensors or devices.

19. The system of claim 15, wherein a notification is transmitted to one or more computing devices to indicate the in-use status of the physical conference space.

20. The system of claim 15, wherein a check-out operation is performed to indicate an available status of the physical conference space at an end of the video conference.
